(19) United States
(12) Patent Application Publication
(10) Pub. No.: US 2026/0220681 A1
(43) Pub. Date: Jul. 30, 2026

(54) ENSEMBLE MODEL USING TRANSFER LEARNING FOR PREDICTING TREATMENT EFFECTS

(71) Applicant: Maplebear Inc., San Francisco, CA (US)

(72) Inventors: Trace Levinson, Brooklyn, NY (US); Shishir Kumar Prasad, San Ramon, CA (US)

(21) Appl. No.: 19/041,579

(22) Filed: Jan. 30, 2025

(51) Int. Cl. G06Q 30/0601

(52) U.S. Cl. CPC G06Q 30/0631; G06Q 30/0641

(57) ABSTRACT

An online system applies an ensemble of two or more machine-learning models to accurately predict a likelihood of user interaction with one or more items on a computer system. The online system applies a first machine-learning model to generate user affinity scores describing a likelihood of user interaction with an item. The generated user affinity scores are then fed as input to a second machine-learning model, the second machine-learning model configured to predict a difference of likelihood of user interaction with the item based on a treatment modifying the item. The ensemble of machine-learning models enables the online system to predict the effects of various factors on user interactions with greater granularity.

### BACKGROUND

Computer systems may leverage affinity scores representing a likelihood of user interaction or engagement with different items or objects to select content items for presentation to the users. Traditional affinity scores are typically based on information describing the user's interests or previous interactions, as well as on information describing different items or content. However, these approaches typically assume constant presentation of items, such that affinity scores represent likely user actions with that constant presentation. However, other factors may influence a user's likelihood of interacting with items, such as treatments or modifications to the presentation of an item to the user, which may appeal differently to different users. These systems that measure treatment effect may be ineffective at incorporating direct user-item affinity information.

A challenge in using direct user-item affinity information for the measurement of treatment effects lies in the complexity and scale of the data. Specifically, user embeddings may encode representations of user preferences or behaviors in a latent space. Such embeddings are often large and noisy, particularly when derived from diverse and high-dimensional datasets. This noise can obscure relevant patterns and relationships, diminishing the performance of predictive models that predict the impact of treatments on user actions. Additionally, the inclusion of overly complex embeddings may lead to inefficiencies in model training and deployment, as the noise requires additional computational resources to manage and may result in inaccurate predictions. A more effective approach is thus needed to use meaningful cross-domain information while minimizing the detrimental impact of noisy or irrelevant data.

### SUMMARY

To incorporate affinity scores and measure treatment effect for varying presentation, an ensemble of machine-learning models is applied to accurately predict a treatment effect of a particular treatment relative to a control. The ensemble of machine-learning models may include a user affinity model that includes a trained model for generating user affinity score along with a treatment effect prediction model that incorporates information from the user affinity model for predicting the treatment effect score. This produces a treatment effect score based on various user, item, and treatment information without sacrificing the granularity of individual relevant features for particular items and particular users.

In one or more embodiments, the machine-learning models include a user affinity model. The user affinity model may receive user features and item features as input to generate a user affinity score describing a user's likelihood of interacting with one or more items.

In one or more embodiments, the machine-learning models include a treatment effect prediction model. The treatment effect prediction model may receive the user affinity score generated by the user affinity model as input. Additionally, the treatment effect prediction model may receive one or more treatment features describing treatments or modifications that may influence a user's likelihood to interact with certain items. Based on the user affinity scores and treatment features, the treatment effect prediction model generates a treatment effect score describing the user's expected response of the treatment relative to the unmodified presentation on a user's interactions. This treatment effect may then be used to determine whether to modify the presentation of the content item for the user. For example, the treatment effect may describe a relative change in an expected user interaction rate with the treatment and may be used to determine whether to present the treatment. The treatment effect may be evaluated in addition to other considerations, such as a cost of applying the treatment, in determining whether to apply the treatment for that user and that item. By incorporating individual information about the user and item from the user affinity score, the treatment effect prediction model can reuse information from a user affinity model and repurpose it for individualized treatment effect prediction.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is an example architecture for an ensemble of machine-learning models for accurately predicting a likelihood of user interaction with one or more items based on user-item affinity and one or more treatments.

FIG. 4 is a flowchart for a method for applying an ensemble of machine-learning models, in accordance with some embodiments.

### DETAILED DESCRIPTION

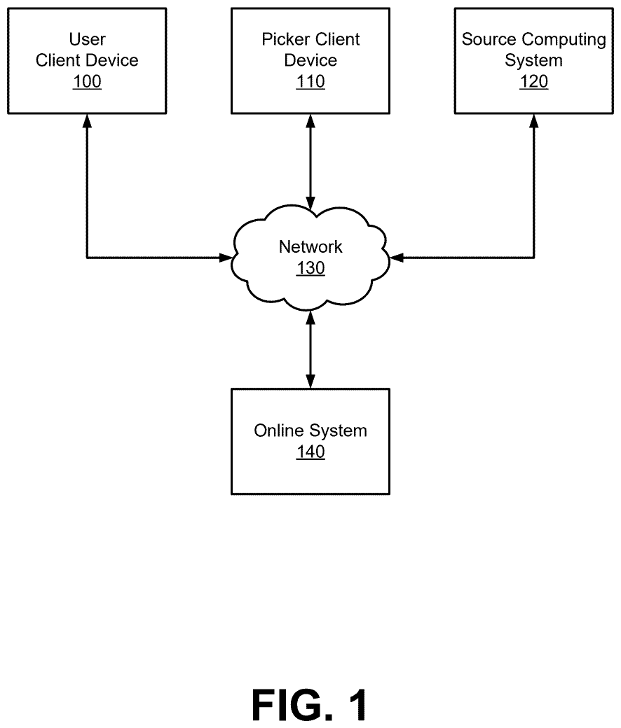

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availability. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

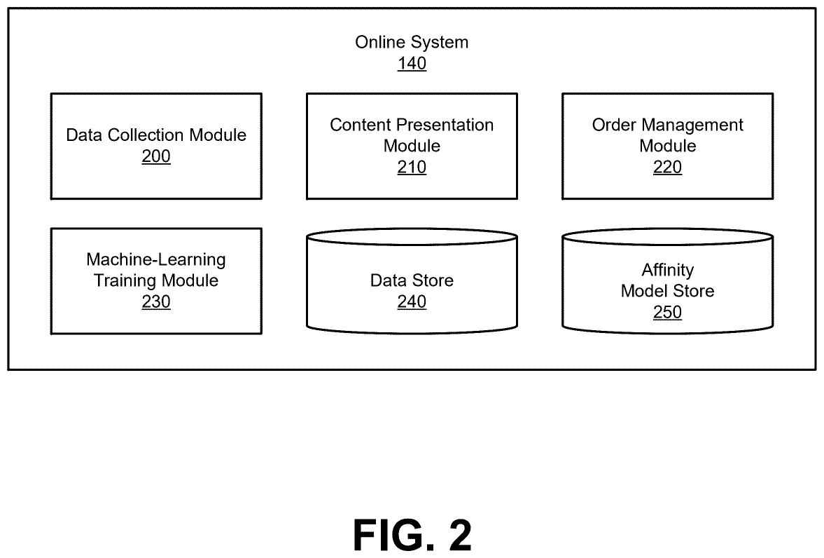

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, and an affinity model store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

In one or more embodiments, the data store 240 stores trained machine-learning models including one or more user affinity models. In some embodiments, user affinity models are trained based on historical user interactions between users and items of the online system 140 to predict a likelihood of user interaction with an item based at least in part on user features describing a user and item features describing an item.

In one or more embodiments, the data store 240 additionally stores trained machine-learning models including one or more treatment effect prediction models. Treatment effect prediction models may be trained to predict the impact of a treatment on a likelihood of user interaction with an item. Treatments that may impact likelihood of user interaction may include, for example, various ways of presenting the item to a user and various characteristics or aspects of the item that may be presented to the user along with the item. For example, the number of items presented to the user at one time may be specified as different treatments (e.g., whether to present two, three, four, etc., items at once to a user in response to a query). In addition, the font size or style, image, display colors, layout and composition, etc., may all be treatments that may be modified to change display of the item and may affect user likelihoods in interacting with the item. In addition, these and other treatments may incur different costs by the online system for presenting information related to the item. For example, the certain treatments may customize or personalize presentation of the item. As one example, a treatment may include whether to present an item alongside a customized recipe based on other items in a user's order or cart, such that applying the treatment may include obtaining additional information about the item, relevant recipes, and other database access and presentation customization steps that may otherwise not be performed. These treatments may thus be selectively applied based on the treatment effect score.

Certain treatments may also affect other presented information about the item, such as the particular properties shown about an item (e.g., to customize whether to display certain characteristics), or to modify the price or reflect potential sales, discounts, or the like, and may be offered by the online system 140 and/or by a source, e.g., may be a sale specific to a store or warehouse represented on the online system. These modified prices may also incur a cost in the modified price or marketing budget allocable to the treatment.

Treatments may be associated with one or more treatment features, the treatment features describing aspects of the treatment that may impact user interaction based on the treatment. For example, treatment features may include display characteristics of the item, features of the treatment presentation, a store or shopfront associated with the treatment, items affected by the treatment, a layout or placement of the treatment in a display of the online system 140, a promotion type, or the like.

In one or more embodiments, the user affinity models and/or the treatment effect prediction models may be associated with respective types of interactions between users and items, or may describe a likelihood of any interaction between users and items. For example, in some embodiments, the data store 240 may store individual user affinity models and/or treatment effect models trained on, for example, each of purchasing items, repurchasing items, recent purchase history, clicks, conversions, saving items, etc., and may apply the individual user affinity models and/or treatment effect models based on desired user interactions.

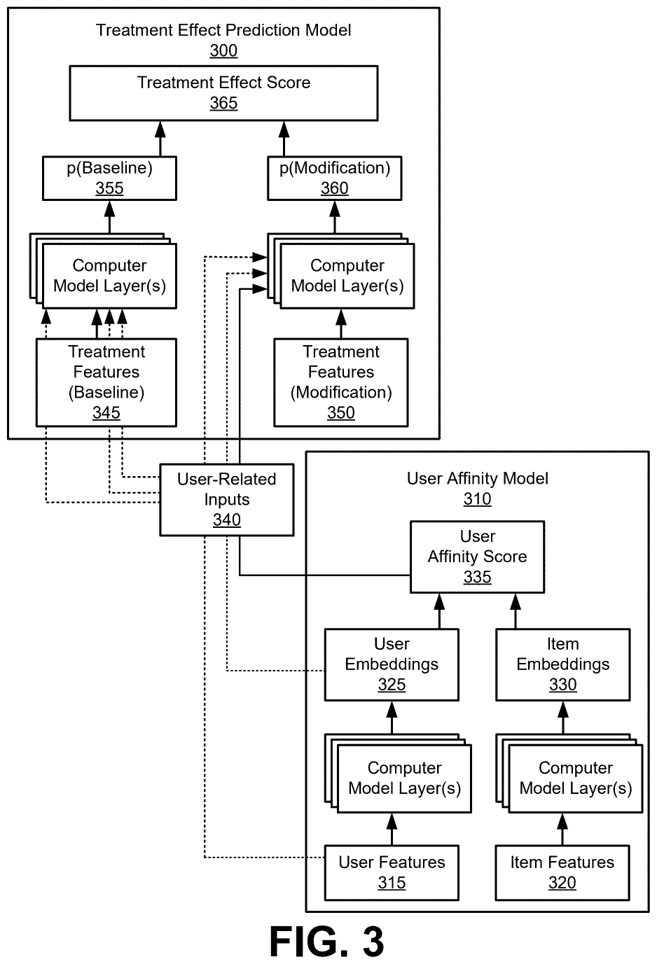

Machine-learning models of the online system 140 may receive various inputs, including, for example, user-related inputs, item-related inputs, treatment feature inputs, or features describing other elements of the online system. In one or more embodiments, as discussed further in conjunction with FIG. 3, two or more machine-learning models of the online system 140 may be combined into an ensemble model, wherein an output (or intermediate result) of a first machine-learning model may be received as input by a second machine-learning model. For example, one or more treatment effect prediction models may receive user affinity scores produced by a user affinity model as input, such that an output likelihood of user interaction based on the treatment is a modification of the user affinity score. Information processed by ensemble machine-learning models thus have the benefit of incorporating various input features from each of the composite machine-learning models, such that a final output of the ensemble of machine-learning models may be more nuanced or granular than any individual output of the composite machine-learning models.

FIG. 3 is an example architecture for an ensemble of machine-learning models for accurately predicting a likelihood of user interaction with one or more items based on user-item affinity and one or more treatments. In the example of FIG. 3, the ensemble of machine-learning models comprises a user affinity model 310 and a treatment effect prediction model 300, wherein a user affinity score 335 output by the user affinity model 310 may be used as input to the downstream treatment effect prediction model 300 to generate a treatment effect score 365. In other examples, the ensemble of machine-learning models may comprise different or additional machine-learning models, and the machine-learning models may receive or output different features and/or information.

In the example ensemble of FIG. 3, the user affinity model 310 may be trained on historic data describing user actions performed by a plurality of users across a plurality of items of the online system 140. In various embodiments, the user affinity model 310 may output multiple types of user affinity scores, each user affinity score trained on a different subset of user action data and representing a specific type of user-item interaction, e.g., user affinity scores representing likelihoods of purchase, repurchase, click, conversion, saving, or bookmarking. In other embodiments, the user affinity model 310 may output a single user affinity score representing a likelihood of any type of user-item interaction. Because the user affinity model 310 is trained with respect to specific historic user actions across a plurality of users and items, the user affinity score 335 may be agnostic to other relevant factors of the online system 140, such as treatments affecting items or users. Thus, although the user affinity score 335 may accurately predict likelihood of user interaction with items absent other factors, the user affinity score may fail to represent likelihood of user interaction when various treatments are available on the online system 140 and evaluate the relative effect of such treatments.

The treatment effect prediction model 300 may be trained on historic data describing a difference in user behavior on the online system 140 with respect to treatments. As previously discussed, treatments may be a sale, discount, or promotion affecting one or more items on the online system 140, may be generated for a specific user of the online system or made available to all users of the online system, and may affect subsets of items (e.g., all items from a given source location, items of a particular category or type, etc.). In one or more embodiments, the treatment effect prediction model 300 outputs a treatment effect score 365 representing a predicted difference in a user's interaction with an item relative to a baseline treatment (e.g., no ongoing sale or discount). In other embodiments, the treatment effect prediction model 300 outputs a treatment effect score representing a predicted difference in a user's interaction with an item relative to a generic user's interaction with an item given the treatment (e.g., an “average” likelihood of interaction with a treatment across all users of the online system 140). By modifying the user affinity score 335 output by the user affinity model 310, the treatment effect prediction model 300 generates a treatment effect score 365 incorporating both standard user-item affinity and more granular user-treatment affinity.

In one or more embodiments, one or both of the user affinity model 310 and/or the treatment effect prediction model 300 may be two-tower models comprising two independent branches of computer model layers that are processed separately by the online system 140. For example, as shown in FIG. 3, a user affinity model 310 may be a two-tower model comprising a first branch generating user embeddings 325 and a second branch generating item embeddings 330, which are combined by the user affinity model to output a user affinity score 335. In another example, the treatment effect prediction model 300 may be a two-tower model comprising a first branch generating a baseline probability of interaction for treatment features (p(Baseline) 355) and a second branch generating a modified probability of interaction based on user affinity score (p(Modification 360), which are combined by a loss function to output a treatment effect score 365.

In other embodiments, one or both of the user affinity model 310 and/or the treatment effect prediction model 300 may be different types of machine-learning models, and the ensemble models may include additional or different models than shown here.

As previously discussed, the user affinity model 310 is configured to receive user features 315 and item features 320 to determine a user affinity score 335, the user affinity score representing a likelihood of user interaction with an item. User features 315 may be historic, demographic, or other feature information describing a user of the online system 140 (e.g., a user for whom content is being requested), which may be stored or retrieved by the online system. User features 315 may include, for example, previous purchases or interactions by a user with an item, previous purchases or interactions by a user with other features of the online system 140, a location, age group, or other demographic information describing a user, or the like. Similarly, item features 320 may be historic or other feature information describing a user of the online system (e.g., an item which is available for presentation and/or purchase by a user). Item features 320 may include, for example, intended demographic audiences, price, price adjustments, likelihood of items to be purchased alongside other items (e.g., marshmallows and hot chocolate), or the like. The user affinity model 310 applies one or more computer model layers to the user features 315 to determine a set of user embeddings 325 and applies one or more different computer model layers to the item features 320 to determine a set of item embeddings 330.

The user affinity model 310 determines a user affinity score 335 based on the user embeddings 325 and the item embeddings. For example, in some embodiments, the user affinity score 335 may be determined based on a number or percentage of shared or similar characteristics between the user embeddings 325 and the item embeddings 330. In other examples, the user affinity score 335 may be determined based on other methods, e.g., various other comparisons or functions between the user embeddings 325 and the item embeddings 330. Additionally, in various embodiments, the user affinity model 310 may receive other features or embeddings as inputs, such as user feature data describing other users with one or more similarities to a target user of the online system 140, item feature data describing other users with one or more similarities to a target item of the online system, or the like.

The user affinity score 335 output by the user affinity model 310 may be described in conjunction with the user embeddings 325 and the user features 315 as user-related inputs 340. One or more of the user-related inputs 340 may be fed to a downstream treatment effect prediction model 300. In some embodiments, the user affinity score 335 may be the only user-related input 340 fed to the downstream treatment effect prediction model 300. In other embodiments, the user affinity score 335, the user embeddings 325, and the user features 315 may all be fed, in part or entirely, to the downstream treatment effect prediction model 300. In other embodiments, one or more other types of data may be included in the user-related inputs 340 and may be fed to the downstream treatment effect prediction model 300.

The treatment effect prediction model 300 receives a first set of baseline treatment features 345 and a second set of modification treatment features 350. In some embodiments, the baseline treatment features 345 describe a zero treatment (e.g., no sale or discount being applied), while the modification treatment features 350 describe an available treatment of the online system (e.g., a sale or discount associated with a target item). The treatment effect prediction model 300 additionally receives the set of user-related inputs 340 as described previously. In some embodiments, the treatment effect prediction model 300 receives the set of user-related inputs 340 in only one branch of a two-tower model, e.g., such that the user-related inputs are processed by one or more computer model layers in conjunction with the modification treatment features 350, but not with the baseline treatment features 345 or vice versa. In other embodiments, the treatment effect prediction model 300 receives the set of user-related inputs 340 in both branches of a two-tower model, e.g., such that the user-related inputs are processed separately with the modification treatment features 350 in one branch and with the baseline treatment features 345 in a second branch. In one or more embodiments, the treatment effect prediction model 300 receives at least a user affinity score 335 of the user-related inputs in conjunction with the modification treatment features 350, such that the output probability of that branch of the two-tower model represents a likelihood of that specific user interacting with a specific item (represented by the user affinity score) with respect to the modified treatment (represented by the modified treatment).

In various embodiments, the treatment effect prediction model 300 may generate a baseline probability 355 representing a likelihood of user interaction with an item assuming a baseline (e.g., a zero or constant) treatment and a modified probability 360 representing a likelihood of user interaction with the item with respect to a particular available treatment. The modified probability 360 is based at least in part on the user affinity score 335 output by the user affinity model 310, as well as the modification treatment features 350.

The treatment effect prediction model 300 determines, from the baseline probability 355 and the modified probability 360, a treatment effect score 365. In some embodiments, the treatment effect score 365 is determined by a loss function. In other embodiments, the treatment effect score 365 may be determined by other methods that suitably represent a predicted difference in the user's interaction with an item given the modified treatment relative to the baseline treatment.

In various embodiments, the treatment effect score 365 may be used by the online system 140 to determine one or more items or treatments to present to the user. In other embodiments, the treatment effect score 365 may be further applied to one or more downstream machine-learning models so as to incorporate other factors that may impact user interaction with items on the online system 140.

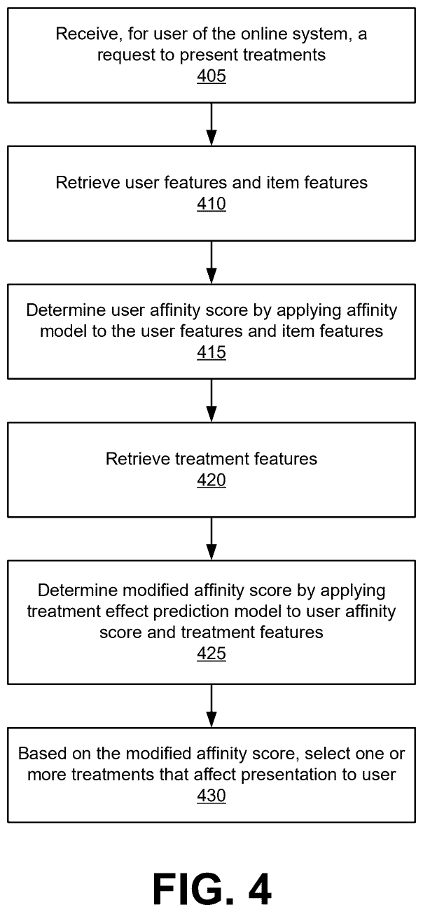

FIG. 4 is a flowchart for a method for applying an ensemble of machine-learning models, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

An online system 140 receives 405 a request to present one or more treatments or items to a user of the online system. In some embodiments, for example, the request may be a request to present one or more items to the user of the online system 140, wherein at least one of the items is associated with at least one treatment. In other embodiments, the request may be a request to present one or more treatments available on the online system 140, e.g., to populate a portion of a user interface with ongoing sales, promotions, or discounts.

The online system 140 retrieves 410 a set of user features describing the user of the online system and a set of item features describing one or more items of the online system. The online system 140 applies 415 a user affinity model 310 to the set of user features and set of item features, the user affinity model 310 trained on historic user interactions to predict a likelihood of interaction by the user with the one or more items. In various embodiments, the online system 140 may apply one or more user affinity models, each affinity model configured to predict a likelihood of a specific interaction by the user with one or more items, e.g., conversion, click, or the like, or may select a specific user affinity model to prioritize a specific type of interaction. In some embodiments, the online system 140 receives a set of user affinity scores, the set of user affinity scores describing likelihoods of user interaction with each of a set of items.

The online system 140 additionally retrieves 420 a set of treatment features describing one or more available treatments of the online system. In some embodiments, the online system 140 retrieves a set of treatment features associated with items represented by the item features or with a source of at least one of the items, e.g., treatment features representing treatments that may be applied to or otherwise modify the items.

The online system determines 425 a set of modified affinity scores by applying a treatment effect prediction model to at least the set of user affinity scores and the set of treatment features. In some embodiments, the set of modified affinity scores may be further based at least in part on the user features or other user-related inputs previously used in the user affinity model. In some embodiments, the set of modified affinity scores represents a difference of probability of interaction by the user with the item and the treatment relative to the probability of interaction by the user with the item without the treatment or with a “baseline” treatment. That is, the treatment effect prediction model is configured to generate a likelihood of user interaction with an item without the treatment and a likelihood of user interaction with an item with a treatment. The treatment effect prediction model then determines the modified affinity score based on these likelihoods, such as by applying a loss function as a difference of the respective likelihoods of user interaction.

Based on the set of modified affinity scores, the online system 140 selects 430 one or more treatments and/or one or more items for presentation to the user and transmits the selected treatments and/or items for display.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, for a user of an online system, a request to present one or more treatments;
retrieving, by the online system, user features and item features;
generating, for an item, a user affinity score that represents a likelihood of interaction between the user and the item, wherein generating the user affinity score for the item comprises applying an affinity model to the user features and the item features, wherein the affinity model is a trained machine learning model;
retrieving treatment features describing a plurality of treatments available on the online system;
generating, for each treatment of the plurality of treatments, a treatment effect score by applying a treatment effect prediction model to the user affinity score and the treatment features, the treatment effect scores representing a predicted change in likelihood of interaction between the user and the item based on the treatment, wherein the treatment effect prediction model is a trained machine learning model;
based on the treatment effect scores, selecting one or more treatments of the plurality of treatments for presentation to the user of the online system; and
generating user interface information for a device of the user of the online system based on the selected one or more treatments, wherein generating the user interface information causes the device to display a user interface containing the user interface information.

2. The method of claim 1, wherein generating, for the item, the user affinity score comprises:
applying a set of neural network layers of a user tower of a two-tower model to the user features to generate a user embedding;
applying a set of neural network layers of an item tower of a two-tower model to the item features to generate an item embedding; and
aggregating the user embedding and the item embedding to generate the affinity scores.

3. The method of claim 2, wherein generating, for each treatment of the plurality of treatments, the treatment effect score comprises further applying the treatment effect prediction model to the user embedding.

4. The method of claim 2, wherein generating, for each treatment of the plurality of treatments, the treatment effect score comprises further applying the treatment effect prediction model to the item embedding.

5. The method of claim 1, wherein generating, for each item of a set of items, a user affinity score comprises generating a value between 0 and 1 representing a probability of interaction by the user with the item associated with the user affinity score.

6. The method of claim 1, wherein generating, for each treatment of the plurality of treatments, the treatment effect score comprises generating a value between 0 and 1 representing a probability of interaction by the user with the item associated with the treatment effect score.

7. The method of claim 1, wherein each treatment effect score represents a difference in probability of interaction by the user with the item and the treatment relative to the probability of interaction by the user with the item without the treatment.

8. The method of claim 1, wherein generating the user interface information based on the selected one or more treatments comprises generating instructions to present the item in the user interface based on the selected one or more treatments.

9. A computer program product comprising a non-transitory computer-readable storage medium having instructions encoded thereon that, when executed by a processor, cause the processor to perform steps comprising:
receiving, for a user of an online system, a request to present one or more treatments;
retrieving, by the online system, user features and item features;
generating, for an item, a user affinity score that represents a likelihood of interaction between the user and the item, wherein generating the user affinity score for the item comprises applying an affinity model to the user features and the item features, wherein the affinity model is a trained machine learning model;
retrieving treatment features describing a plurality of treatments available on the online system;
generating, for each treatment of the plurality of treatments, a treatment effect score by applying a treatment effect prediction model to the user affinity score and the treatment features, the treatment effect scores representing a predicted change in likelihood of interaction between the user and the item based on the treatment, wherein the treatment effect prediction model is a trained machine learning model;
based on the treatment effect scores, selecting one or more treatments of the plurality of treatments for presentation to the user of the online system; and
generating user interface information for a device of the user of the online system based on the selected one or more treatments, wherein generating the user interface information causes the device to display a user interface containing the user interface information.

10. The computer program product of claim 9, wherein generating, for the item, the user affinity score comprises:
applying a set of neural network layers of a user tower of a two-tower model to the user features to generate a user embedding;
applying a set of neural network layers of an item tower of a two-tower model to the item features to generate an item embedding; and
aggregating the user embedding and the item embedding to generate the affinity scores.

11. The computer program product of claim 10, wherein generating, for each treatment of the plurality of treatments, the treatment effect score comprises further applying the treatment effect prediction model to the user embedding.

12. The computer program product of claim 10, wherein generating, for each treatment of the plurality of treatments, the treatment effect score comprises further applying the treatment effect prediction model to the item embedding.

13. The computer program product of claim 9, wherein generating, for each item of a set of items, a user affinity score comprises generating a value between 0 and 1 representing a probability of interaction by the user with the item associated with the user affinity score.

14. The computer program product of claim 9, wherein generating, for each treatment of the plurality of treatments, the treatment effect score comprises generating a value between 0 and 1 representing a probability of interaction by the user with the item associated with the treatment effect score.

15. The computer program product of claim 9, wherein each treatment effect score represents a difference in probability of interaction by the user with the item and the treatment relative to the probability of interaction by the user with the item without the treatment.

16. The computer program product of claim 9, wherein generating the user interface information based on the selected one or more treatments comprises generating instructions to present the item in the user interface based on the selected one or more treatments.

17. A computer system comprising:
one or more processors that execute instructions; and
a non-transitory computer-readable storage medium having instructions, executable by the one or more processors, for:
receiving, for a user of an online system, a request to present one or more treatments;
retrieving, by the online system, user features and item features;
generating, for an item, a user affinity score that represents a likelihood of interaction between the user and the item, wherein generating the user affinity score for the item comprises applying an affinity model to the user features and the item features, wherein the affinity model is a trained machine learning model;
retrieving treatment features describing a plurality of treatments available on the online system;
generating, for each treatment of the plurality of treatments, a treatment effect score by applying a treatment effect prediction model to the user affinity score and the treatment features, the treatment effect scores representing a predicted change in likelihood of interaction between the user and the item based on the treatment, wherein the treatment effect prediction model is a trained machine learning model;
based on the treatment effect scores, selecting one or more treatments of the plurality of treatments for presentation to the user of the online system; and
generating user interface information for a device of the user of the online system based on the selected one or more treatments, wherein generating the user interface information causes the device to display a user interface containing the user interface information.

18. The computer system of claim 17, wherein generating, for the item, the user affinity score comprises:
applying a set of neural network layers of a user tower of a two-tower model to the user features to generate a user embedding;
applying a set of neural network layers of an item tower of a two-tower model to the item features to generate an item embedding; and
aggregating the user embedding and the item embedding to generate the affinity scores.

19. The computer system of claim 18, wherein generating, for each treatment of the plurality of treatments, the treatment effect score comprises further applying the treatment effect prediction model to the user embedding.

20. The computer system of claim 18, wherein generating, for each treatment of the plurality of treatments, the treatment effect score comprises further applying the treatment effect prediction model to the item embedding.
